(19) United States
(12) Patent Application Publication
(10) Pub. No.: US 2010/0248538 A1
(43) Pub. Date: Sep. 30, 2010

(54) ELECTRICAL CONNECTOR HAVING A SHELL DEFINING A PAIR OF WINGS AT OPPOSITE SIDES THEREOF

(75) Inventors: TZU-FAN KUO, Tu-Cheng (TW); KUO-CHUN HSU, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/750,592

(22) Filed: Mar. 30, 2010

(30) Foreign Application Priority Data
Mar. 31, 2009 (CN) 200920301772.3

(51) Int. Cl. H01R 13/73

(52) U.S. Cl. 439/571

(57) ABSTRACT

An electrical connector comprises an insulator, a plurality of terminals retained in the insulator and a shell installed on the insulator. The insulator comprises a base portion and mating portion extending from the base portion. At lest one terminal has a contact portion disposed in the mating portion of the insulator. The shell defines a receiving room and comprises a side wall and a supporting arm extending out of the receiving room from the side wall. the supporting arm comprises a locking portion and a supporting beam connected with the locking portion and attached to the shell.

### BACKGROUND OF THE INVENTION

1. Field of the Invention

The present invention relates to an electrical connector, and more particularly to an electrical connector having a shell defining a pair of wings at opposite sides thereof for strengthening the rigidity of the shell.

2. Description of the Related Art

Chinese Utility Model Pat. No. 201038503Y discloses an electrical connector adapted for mounting onto a printed circuit board. The electrical connector includes an insulator, a plurality of terminals disposed in the insulator and a shielding shell surrounding the insulator. The shielding shell has a pair of ear portions at opposite sides thereof and extending outwardly. Each ear portion defines a through hole thereon for inserting a retaining member therein and a leg extending rearward from an upper edge thereof perpendicularly. When the electrical connector is mounted onto the printed circuit board, the leg of the ear portion will not only take up some additional space, but also increase the difficulty of the soldering procedure. Hence, an electrical connector which can solve the above mentioned problem is required.

### SUMMARY OF THE INVENTION

An object of the present invention is to provide an electrical connector which occupies less space of a printed circuit board.

Another object of the present invention is to provide an electrical connector having a shell with a pair of supporting arms for preventing distortion of the shell.

In order to achieve the above-mentioned object, an electrical connector comprises an insulator, a plurality of terminals retained in the insulator and a shell installed on the insulator. The insulator comprises a base portion and mating portion extending from the base portion. At least one terminal has a contact portion disposed in the mating portion of the insulator. The shell defines a receiving room and comprises a side wall and a supporting arm extending out of the receiving room from the side wall. The supporting arm comprises a locking portion and a supporting beam connected with the locking portion and attached to the shell.

Other advantages and novel features of the invention will become more apparent from the following detailed description of the present embodiment when taken in conjunction with the accompanying drawings.

### BRIEF DESCRIPTION OF THE DRAWINGS

FIG. 1a is a perspective view of a first embodiment of an electrical connector in accordance with the present invention;

FIG. 1b is a perspective view of the electrical connector shown in FIG. 1a assembled onto a printed circuit board;

FIG. 2 is an exploded perspective view of the electrical connector shown in FIG. 1a;

FIG. 3 is another exploded view of the electrical connector shown in FIG. 1a;

FIG. 4 is a perspective view of a second embodiment of the electrical connector in accordance with the present invention; and

FIG. 5 is a perspective view of a third embodiment of the electrical connector in accordance with the present invention.

### DETAILED DESCRIPTION OF THE INVENTION

Reference will now be made to the drawing figures to describe the preferred embodiments of the present invention in detail.

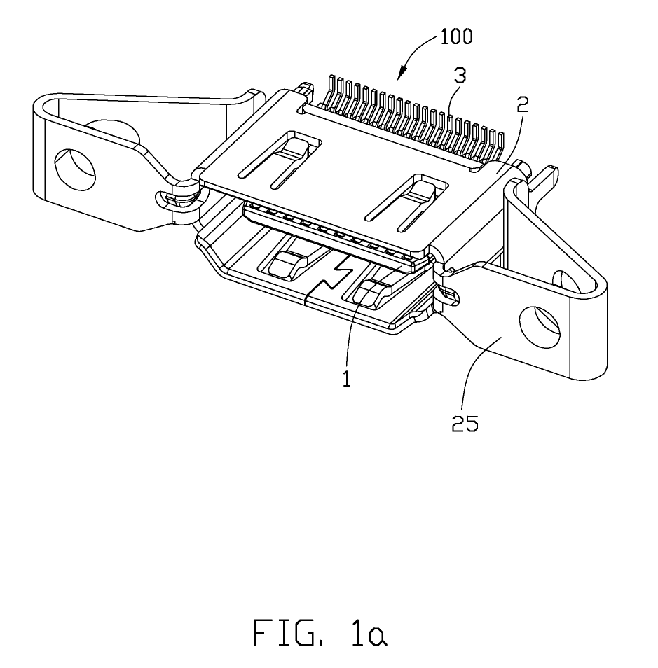

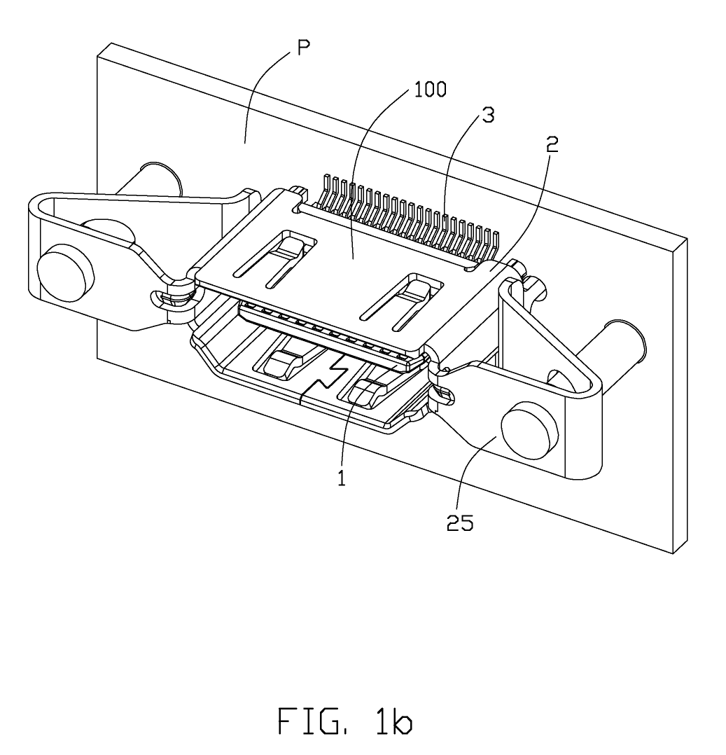

Referring to FIGS. 1a-3, a first embodiment of an electrical connector 100 made in accordance with the present invention is provided. The electrical connector 100 comprises an insulator 1, a plurality of terminals 3 disposed in the insulator and a shielding shell 2 surrounding the insulator 1.

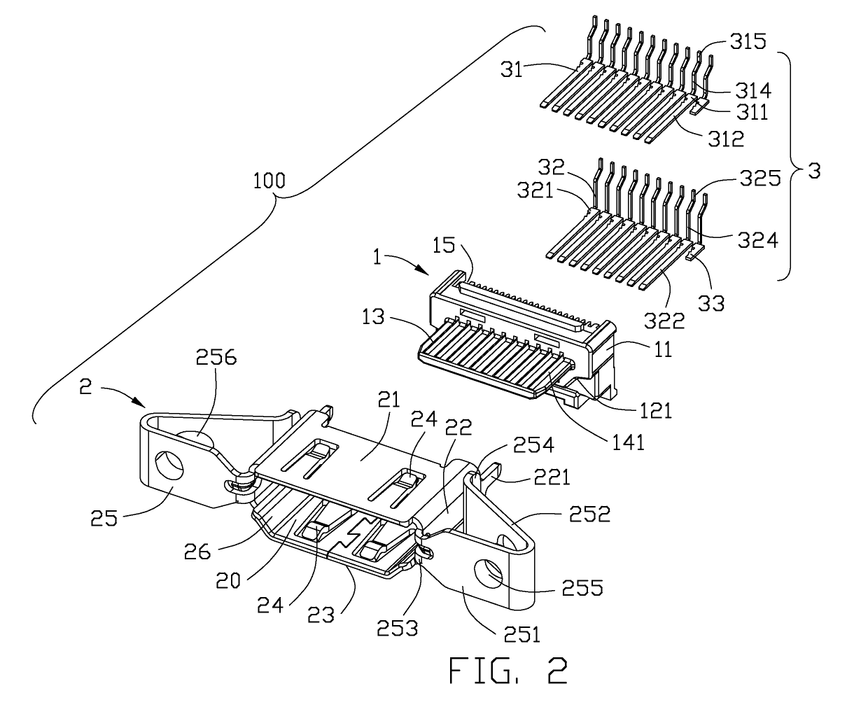

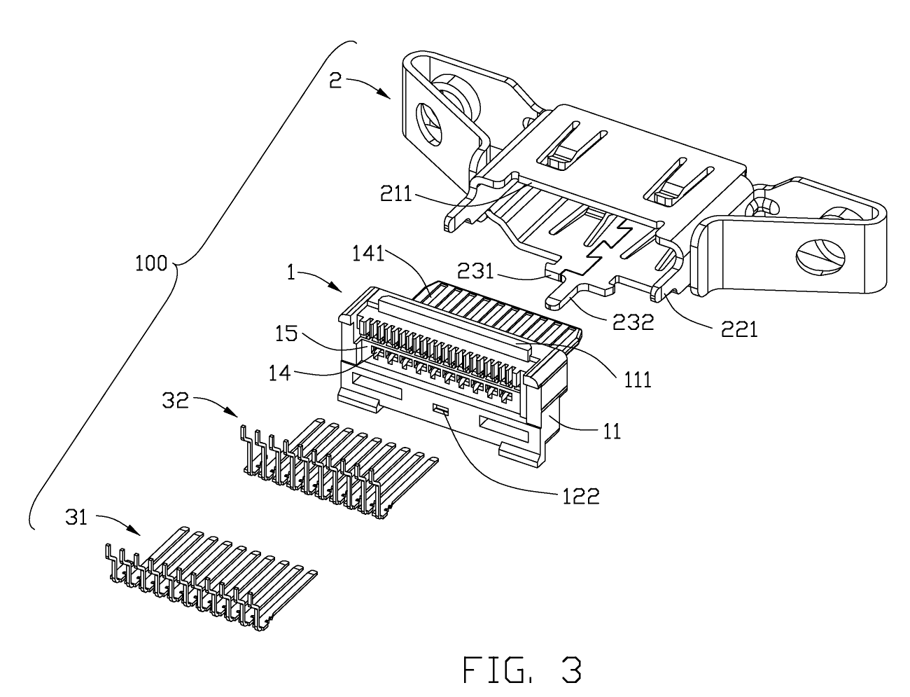

Referring to FIG. 2 and FIG. 3, the insulator 1 comprises a base portion 11 and a mating portion 13 perpendicularly extending from a front face of the base portion 11. The base portion 11 defines a recess 15 in a rear face opposite to the front face. A plurality of grooves 14 extend along a rear-to-front direction from the recess 15 and expose outwardly at opposite faces of the mating portion 13 thereby forming passageways 141 arranged along a transverse direction perpendicularly to the rear-to-front direction. An elongated rib 111 protrudes outward from a top face of the base portion 11. In addition, an aperture 122 is defined under the mating portion 13 and extends along the rear-to-front direction.

The terminals 3 are arranged into an upper row 31 and a lower row 32, each of which is configured identically. Each terminal 3 has a holding portion 311/321, a contact beam 312/322 extending forward from a front end of the holding portion and a tail 315/325 perpendicularly extending from the other end of the holding portion and projecting outwardly in a slantwise manner. The tails 325 of the lower row terminals 32 are longer than that of the upper row terminals 31 therefore all the tails 315, 325 are orderly arranged in a row and staggered with each other along the transverse direction. Each of the upper row and lower row terminals 31, 32 include a spare terminal 33 having no contact beam. The terminals 3 are inserted into the grooves 14 from the rear of the insulator 1 with the holding portions 311, 321 secured in the grooves 14 and the contact beams 312, 322 received in the passageways 141 of the mating portion 13.

Referring to FIG. 2 and FIG. 3, the shielding shell 2 comprises a top wall 21, a bottom wall 23 opposite the top wall 21 and two side walls 22 joining the top wall 21 and the bottom wall 23 thereby defining a receiving room 20 therebetween. A pair of spring arms 24 project into the receiving room 20 from the top wall 21 and the bottom wall 23 for increasing the interference when a mating connector is inserted thereinto. Each side wall 22 has a leg 221 extending backward for soldering on a printed circuit board P. The bottom wall 23 has a fastening portion 231 protruding backward with a leg 232 at distal end thereof. A pair of supporting arms 25 integrally extend from a front end of the side walls 22 respectively and locate at opposite sides of the receiving room 20. The supporting arm 25 includes a locking portion 251 vertically extending from the side wall 22 and a supporting beam 252 obliquely extending backward from the locking portion 251. A mounting portion 254 is defined at a distal end of the supporting beam 252 and is attached to a rear end of the side wall 22 by a soldering manner or others similarly. The locking portion 251, the supporting beam 252 and side wall 22 form a triangle configuration which is helpful for increasing the rigidity of the supporting arm 25. The locking portion 251 and the supporting beam 252 respectively define a through hole 255, 256 thereon for assembling a screw, refer to FIG 1b.

The shielding shell 2 is assembled on the insulator 1 from the front of the insulator 1 along a front-to-rear direction with the fastening portion 231 fixed in the aperture 122 of the insulator 1 and the leg 232 protruding outwardly. The elongate rib 111 is received in a notch 211 defined at a rear edge of the top wall 21. The mating portion 13 locates in the receiving room 20. The electrical connector 100 can be soldered on a printed circuit board by the tails 315,325 of the terminals 3 soldering thereon. Further more, the electrical connector 100 is further fixed on the printed circuit board by inserting screws through the hole 255, 256 of the supporting arm 25. The supporting beam 252 prevents the locking portion 251 from deforming. The end 254 of the supporting beam 252 is fixed on the side wall 22 and is not fixed on the printed circuit board, so the supporting beam 252 does not take up space of the printed circuit board. As the supporting beam 252 is integrally formed with the locking portion 251 and bent rearwardly to be soldered onto the side wall 22, which can provide a steadfast and preferable supporting force on the locking portion 251 and save the space on the printed circuit board.

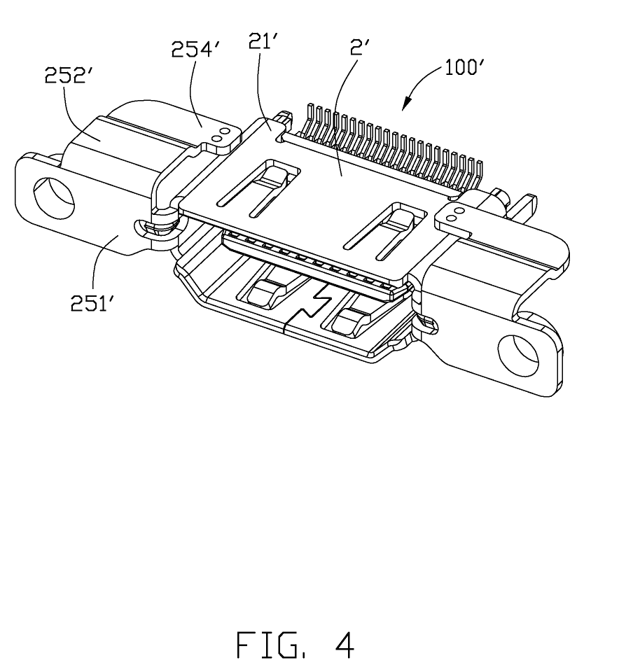

FIG. 4 discloses a second embodiment of the electrical connector of the present invention and the only difference from the first embodiment is the configuration of the supporting beam 252′. The supporting beam 252′ extends backward from a top edge of the locking portion 251′ with a side edge 254′ extending sidewardly and being soldered on the rear of the top wall 21′ of the shielding shell 2′.

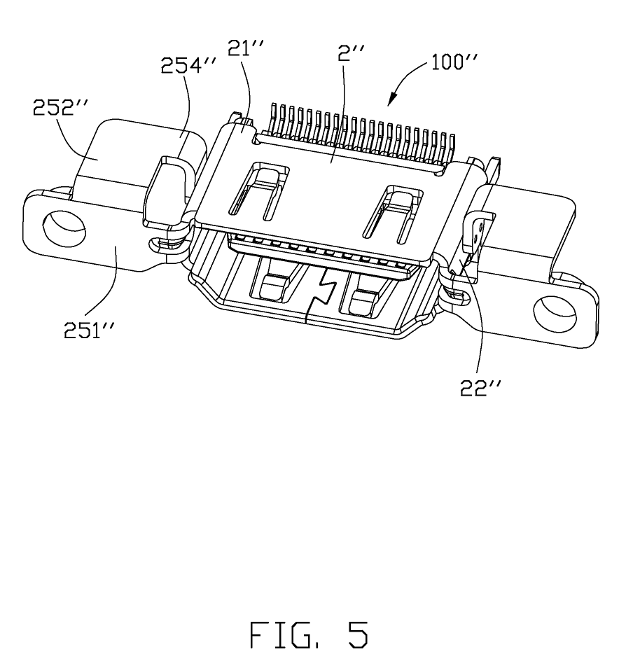

FIG. 5 discloses a third embodiment of the electrical connector of the present invention and the difference from the second embodiment is the configuration of the supporting beam 252″. The side edge 254″ of the supporting beam 252″ is bent downwardly and is soldered on the rear of the side wall 22″of the shielding shell 2″.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector, comprising:
an insulator comprising a base portion and a mating portion extending from the base portion thereof;
a plurality of terminals retained in the insulator, at least one terminal having a contact portion disposed in the mating portion of the insulator; and
a shell defining a receiving room and being installed on the insulator for receiving the mating portion therein; the shell comprising a side wall and a supporting arm extending from the side wall and located out of the receiving room;
wherein the supporting arm comprises a locking portion and a supporting beam connected with the locking portion and attached to the shell.

2. The electrical connector as described in claim 1, wherein the supporting beam is attached to the side wall of the shell.

3. The electrical connector as described in claim 1, wherein the shell further comprises a top wall and a bottom wall defining the receiving room therebetween, the supporting beam is attached to the top wall or the bottom wall.

4. The electrical connector as described in claim 3, wherein the supporting beam extends from a top edge of the locking portion.

5. The electrical connector as described in claim 1, wherein the locking portion and the supporting beam respectively define a through hole in alignment with each other along a mating direction.

6. The electrical connector as described in claim 1, wherein the terminals are arranged into two sets, each set of the terminals comprises a spare terminal having no contact beam.

7. An electrical connector comprising:
an insulative housing defining a base with a mating tongue extending forwardly therefrom in a vertical direction;
a plurality of contacts disposed in the housing with contacting sections exposed upon the mating tongue;
a metallic shell attached to said housing and defining a frame structure enclosing said mating tongue, said shell further including a supporting arm,
said supporting arm including:
a locking portion unitarily extending from a front edge region of the frame structure in a transverse direction perpendicular to said vertical direction with a through hole therein for fastening, and a supporting beam unitarily extending from the locking portion and abutting against an exterior side of the frame for reinforcement of the locking portion during securing.

8. The electrical connector as claimed in claim 7, wherein the supporting beam extends from an outmost end of the locking portion in an oblique direction relative to the locking portion toward a side wall of the shell.

9. The electrical connector as claimed in claim 8, wherein said side wall is an end side wall of the frame structure, where said locking portion extends therefrom.

10. The electrical connector as claimed in claim 8, wherein said supporting beam defines another though hole in alignment with the through hole in the vertical direction.

11. The electrical connector as claimed in claim 7, wherein the supporting beam extending from a side edge of the locking portion in a horizontal direction perpendicular to both said front-to-back direction and said vertical direction.

12. The electrical connector as claimed in claim 11, wherein a distal end of the supporting beam abuts against a side wall of the frame structure, where the locking portion extends.

13. The electrical connector as claimed in claim 12, wherein said side wall is an end side wall of the frame structure.

14. The electrical connector as claimed in claim 7, wherein said frame structure further includes a pair of mount legs downwardly unitarily extending from a bottom edge thereof inside of the locking portion in the transverse direction.

15. The electrical connector as claimed in claim 14, wherein said mounting legs is aligned with a corresponding end side wall of the frame structure in the vertical direction.

16. An electrical connector comprising:
an insulative housing defining a base with a mating tongue extending forwardly therefrom in a vertical direction;
a plurality of contacts disposed in the housing with contacting sections exposed upon the mating tongue;
a metallic shell attached to said housing and defining a frame structure enclosing said mating tongue, said shell further including a supporting arm,
said supporting arm including:
a locking portion unitarily extending from a front edge region of the frame structure in a transverse direction perpendicular to said vertical direction with a through hole therein for fastening, and a supporting beam unitarily extending from an outermost end of the locking portion;
wherein
the supporting beam defines another through hole in alignment with the through hole in said vertical direction.

17. The electrical connector as claimed in claim 16, wherein said supporting beam abuts against an end side wall of the frame structure where the locking portion extends.

18. The electrical connector as claimed in claim 17, wherein said supporting beams extending in an oblique direction angled with regard to both the vertical direction and said transverse direction.

19. The electrical connector as claimed in claim 18, wherein said locking portion, the supporting beam and the end side wall together define a triangular configuration.

20. The electrical connector as claimed in claim 17, wherein the supporting beam is secured to the end side wall.
